(19) United States
(12) Patent Application Publication
(10) Pub. No.: US 2008/0220625 A1
(43) Pub. Date: Sep. 11, 2008

(54) Flexible Board Contact Means for Connection of Outer Edge of Printed Circuit Board

(76) Inventor: Per Ligander, Goteborg (SE)

Correspondence Address: ERICSSON INC., 6300 LEGACY DRIVE, M/S EVR 1-C-11, PLANO, TX, 75024, US

(21) Appl. No.: 12/091,389

(22) PCT Filed: Oct. 26, 2005
(86) PCT No.: PCT/SE2005/001602

§ 371 Date: Apr. 24, 2008

(51) Int. Cl. H01R 12/00

(52) U.S. Cl. 439/65

(57) ABSTRACT

The present invention relates to a longitudinal board guide rail for taking up an outer edge of a circuit board and for being provided in a board connection housing and comprising a board receiving portion e.g. a groove or similar, for receiving the circuit board edge. It comprises side plane contact means, flexible and/or displaceable board contact means comprising or being associated with said side plane contact means. Said flexible and/or displaceable contact means are in a first state so arranged or disposed that no contact is enabled with a board, e.g. a board insertion or contact-less state, and in a second state, e.g. a contact state, they are so arranged that contact is established with a board introduced or provided in the board receiving portion. The invention also relates to a board connection having arrangement with a number of such board guide rails.

### FIELD OF THE INVENTION

The present invention relates to a board connection housing arrangement for taking up a number of boards or printed circuit boards. It preferably comprises a backplane, with a number of backplane contact regions for providing contact with boards introduced into the housing, and it comprises a number of first and second board guide rails each having a longitudinal extension which is substantially perpendicular to the planar extension of said backplane and they are adapted to, in a board receiving portion provided in each of said board guide rails, take up a respective edge portion of a respective board.

The invention also relates to a longitudinal board guide rail for taking up an outer edge of a circuit board and for being provided or introduced in a board connection housing. The board guide rail comprises a board receiving portion, for example a groove or similar, for receiving a circuit board edge. The invention also relates to a circuit board intended to be used in a board connection housing arrangement as referred to above and for being introduced in a board guide rail as also referred to above. Still further the arrangement relates to an assembly comprising a board connection housing arrangement with board guide rails and circuit boards for mounting therein.

### STATE OF THE ART

In substantially all known board connection housing arrangements adapted to take up a number of circuit boards, board guide rails are provided and a backplane with backplane contacts is provided for establishing contact with the circuit boards. The contact provisioning by means of the backplane takes place through a contact with a number of contact elements provided on one edge or one side of the circuit board and corresponding contact elements are provided in the housing backplane. Guided by said board guide rails into which two of the other edges or sides of the circuit boards are intended to be introduced, the circuit board is pushed into the housing or into the magazine and the contacts of the circuit board establish contact with the backplane contacts. When e.g. the pins forming the backplane contacts are to be pushed into the sleeve contacts forming the circuit board contacts, or vice versa, a considerable force is needed, which is disadvantageous for several reasons, for example the pins and/or the sleeves may be damaged. One reason that the contact pressure or force that is required is so high is actually due to the large amount of contacts in the backplane. Generally, it is today desired to use as many contacts as possible in the backplane, i.e. as many contacts on the circuit boards as possible. However, the number of connection points of a contact is limited e.g. by the height of the circuit board. Today, a main object is to be able to increase the data rate in general and in the backplane and on the circuit boards in particular. In addition thereto it is important to be able to increase the number of connection points. The high data rates that are needed particularly require a good isolation between signal conductors in order to limit cross talk. This is advantageous as far as Electro Magnetic Compability, EMC, requirements are concerned.

It is however getting more and more difficult to meet the requirements as to data rate, contact density etc. with today known board connection arrangements, i.e. housings or board magazines with Printed Circuit Boards, PCBs.

To summarize, there are several disadvantages associated with the existing, known techniques in this field. A serious drawback is the considerable force that is required in order to bring a board in contact with the backplane. This high force may have as a consequence that the circuit board be exposed to a torque and runs the risk of rotating at least to a very small extent which however may be sufficient to cause damage which also means that there is a risk that components on the circuit boards are detached, damaged or somehow affected. There is also a risk that e.g. pins in the backplane contact are damaged, broken or dislocated. In order to solve these particular problems so called zero force connectors have been developed. Such arrangements are however expensive and complicated.

However, since the number of connections or points that can be provided is limited by the height of the circuit board, more compact contact means are developed, for example with more contact pins, a more dense distribution of the pins, or a smaller distance or pitch between the pins etc. This however means that the risk for crosstalk increases considerably, particularly if also the data rate increases. The thickness of the backplanes is also increased as the number of signal layer increases. This produces problems as far as yield and weight is concerned. In addition thereto the transmission distances or signal paths get long. This is disadvantageous among others as far as the requirements on Electro Magnetic Compability EMC are concerned, although, it is of course also for several other reasons disadvantageous that long signal paths are needed.

### SUMMARY OF THE INVENTION

What is needed is therefore a board connection housing arrangement as initially referred to in which a board easily can be mounted without requiring too much power. An arrangement is also needed through which the number of connection points or connections can be increased as compared to known technology. Still further an arrangement is needed through which the signal or transmission paths need not be so long and particularly through which the signal paths between backplane and components on the circuit board can be reduced. Particularly an arrangement is needed through which the number of connection points can be increased at the same time as the transmission paths or signal paths can be reduced, even more particularly at the same time as the force required in order to provide for connection of such an amount of connection points is not increased to the corresponding extent, or not to any extent, cf. the discussion above concerning a high force being required among others due to the number of connections, e.g. the connector pins and connector sleeves that need to be pushed together, but that a still (much) higher number of connections can be offered without requiring an increased mounting force.

An arrangement is also needed through which the distribution of signal types is facilitated, which particularly has as a secondary effect that cross-talk is reduced or minimized.

A board guide rail is therefore also needed through which one or more of the above mentioned objects can be achieved as well as a circuit board that can be used in a board connection housing arrangement as referred to above and, even more particularly, an assembly comprising a board connection housing arrangement with a plurality of printed circuit boards.

Therefore a board connection housing arrangement as initially referred to is provided wherein the housing further comprises a first and a second side plane whereby at least one of said first and second side planes comprises side plane contact regions. At least some of said first and/or second board guide rails are provided with side plane contact means capable of getting in contact with respective contacts of said first and second side plane contact regions. Substantially in parallel with the longitudinal extension of at least some of said first and/or second board guide rails respective flexible or displaceable, particularly directly or indirectly controllable, (board) contact means are provided which are arranged to be in contact or communication with said side plane contacts or additionally also constitute, e.g. are in one piece with, and form the other end of, said side plane contacts, whereby the said flexible or displaceable contact means in a first state, a contact-less state, are so arranged that no contact is enabled with a board whereas in a second state they are so arranged that contact is provided with a board introduced or provided in the board guide rail receiving portions.

Contact control means are provided for bringing the flexible or displaceable contact means from the first state to the second state and/or vice versa. The contact control means may according to one embodiment be automatically activated to provide for transfer from the first to the second state and vice versa, for example upon insertion of a board or upon actuation of an actuating member. They may also be manually activated or manually controlled in any appropriate way. It should be clear that this can be provided for in many different ways, the main thing being that it also gets possible to have contacts at least on one side, preferably in addition to the backplane, of a circuit board and, e.g. to provide contact between one or more circuit boards and side plane contacts acting in a similar as backplane contacts. Moreover there is a great flexibility in how this can be provided for, for example in a magazine comprising a plurality of receiving portions for taking up circuit boards, all board guide rails can be equipped or arranged as discussed above, only all of them on one of the sides, or some of them on one or both sides, such that it is enabled to provide contact, in addition to via the backplane in a conventional manner, also on one side, or on both sides such that contact can be provided on both sides of a board, particularly additionally to the backplane (but of course also if for some reason it is not desired to have a backplane contact). It is also possible to flexibly select which board guide rails should be equipped as discussed above, or only portions of a board guide rail can be provided with side plane contacts, board contacts.

In a particular embodiment the flexible or displaceable contact means in the first state are so arranged that a board receiving portion is free, i.e. no contact means enter or protrude, at least no to a large extent, into the receiving portion and a board can be received without entering into contact with the flexible or displaceable contact means. In addition thereto, or alternatively, in the second state, said flexible or displaceable contact means may be in electrical and preferably also in physical contact with an introduced board. It should be clear that contact can be established automatically upon introduction of a board or through activation of the contact control means hence forming the means that actually provides for establishment of the contact. The contact control means may advantageously also be used as a means for appropriately locking a circuit board in contact position. In a particular implementation the contact control means comprises contact closing means. Then they may be adapted to bring said flexible or displaceable contact means from the first to the second state when contact between a board and the respective side plane at which the board guide rail is provided, is desired, or automatically at completion of introduction or insertion of a board.

In a particular implementation a flexible or displaceable contact means comprises a spring device. The spring device may be shaped in different manners and may for example be moulded into a plastic guide rail in such a manner that it can be displaced, stretched/compressed, bent or similar such that it can assume the aforementioned first and second states respectively. In one embodiment the spring device comprises spring means with a respective board contact end for, in said second state, being in contact with a board, and a second contact end which constitutes a said side plane contact means or which, for example via an intermediate means, is in contact with a said side plane contact means. Particularly at least a number of the spring devices comprise first and second spring means adapted to be capable of, in said second state, contacting opposite sides of a board edge. In an advantageous embodiment a number of, or all of, said board guide rails each comprises a longitudinally extending recess arrangement adapted to allow insertion or activation of a contact control means. The recess arrangement may comprise two parallel recesses extending on opposite sides of the board receiving portion, for example comprising a groove. It may of course also comprise one single recess only which is located on one side of a receiving opening such that contacts can be provided or activated on one side of the board only.

In a particular implementation the contact control means comprises an elongate member adapted to be introduced into a recess to achieve said second state by bringing the board contact end of the spring in contact with a board. In another embodiment, allowing dual side contacting with opposite sides of a board edge, the contact control means comprises two elongate members or legs adapted to be introduced into said parallel recesses. Said elongate members or legs are preferably, but not necessarily, interconnected at one respective end thereof by a bridging element, which when the elongate members are mounted, is located on a front side, i.e. the side opposite to the backplane of the magazine or housing arrangement. Of course dual side contacting can be allowed irrespectively of the contact control means comprising two elongate members or not. As referred to above it may be provided for in many ways and there may be an internal connection between board contact means for the two opposite sides of an edge of the board such that when the control means is activated on one side, the second state can be achieved on both sides.

Particularly the first or the second or the first and second board guide rail(s) may be provided with flexible or displaceable board contact means, or board contact ends that somehow can be actuated upon such that a first and a different state can be achieved comprising a number of contact members arranged along at least one of the sides of the receiving portion adapted to receive a board.

These contact members may be arranged regularly with a given pitch or with a given density along at least one side. They may of course also be arranged regularly with a given pitch or a given pattern along both sides. However, the contact members may also be arranged groupwise on one or both sides with a regular or irregular pitch. If the contact members are provided on both sides, they may be disposed in a similar manner but they may also be disposed in different manners on the respective sides. Any variation is in principle possible and it is extremely advantageous since in that manner the desired number and location of contacts or connections can be varied and controlled. According to different embodiments may also some first or second guide rails be provided with side plane contact means and board contact means. In other embodiments all first or second guide rails are provided with side plane contact means and board contact means. In still other embodiments some of the first and/or the second guide rails are replaceable such that there will be an option to use board guide rails provided with side plane contact means. Hence it is possible to provide a housing arrangement wherein the inventive concept is partly implemented and wherein some guide rails are of conventional type.

In some implementations the contact control means are adapted to bring the flexible or displaceable contact means into the second state upon introduction thereof into the recess or recesses. In an alternative implementation the contact control means are adapted to bring the flexible or displaceable contact means into the second state upon removal thereof from said recess or recesses or, as referred to above, upon actuation for example by rotation thereof controlling the flexible or displaceable contact means on one or both sides. It is also possible to use board detecting means of any kind detecting when a board is introduced and when actuation should take place to ensure a transfer to the second state, whenever actuation is desired, not necessarily upon introduction of a board, but also at a later stage.

In some embodiments, however, there being a plurality of first and/or second guide rails, there is one separate contact control means for each respective guide rail whereas in other implementations there are one or more contact control means, some of, or one of, or all of, which are adapted to bring the flexible or displaceable contact means from the first to the second state and/or vice versa for a plurality of first guide rails or second guide rails, e.g. comprising a large number of elongate members, pairwise for each guide rail if dual connection is implemented, whereby a long bridging element may be used.

Therefore also a longitudinal board guide rail for taking up one outer edge of a circuit board is provided which is adapted to be provided in a board connection housing arrangement and it comprises a board receiving portion, for example a groove or similar, for receiving the circuit board edge. According to the invention the board guide rail comprises side plane contact means, flexible or displaceable (board) contact means comprising or being associated with or connected to said side plane contact means. Said flexible or displaceable contact means are in a first state so arranged or disposed that no contact is provided or enabled with a board, for example a board insertion state or contact-less state, and in a second state, also called the contact state, they are so arranged that contact is established with a board introduced or provided in the board receiving portion.

Most particularly the flexible or displaceable board contact means are adapted to be actuated by contact control means such that through interaction with said contact control means, said flexible or displaceable contact means can be brought from said first to said second state or vice versa or both. Particularly the flexible or displaceable contact means in the first state are so arranged that the board receiving portion is free and the board can be received without entering into contact with the flexible and/or displaceable contact means. Particularly, in the second state, said flexible or displaceable contact means are in physical contact with an introduced board, or at least in electrical contact. The flexible or displaceable contact means may comprise a spring device, which may comprise spring means with a respective board contact and be adapted to, in said second state be in contact with a board, and a second contact end constituting said side plane contact means or alternatively being in contact with said side plane contact means, directly or indirectly, via intermediate means. The spring device may comprise first spring means or first and second spring means oppositely located but parallel with one another and adapted to be capable of, in said second state, contacting opposite sides of a board edge, i.e. the spring device may comprise two legs and said board guide rail may comprise a longitudinally extending recess arrangement adapted to allow insertion and extraction or activation of a contact control means wherein the recess arrangement may comprise one longitudinal recess or two parallel longitudinal recesses extending in parallel with, or parallelly on opposite sides of the longitudinal board edge receiving portion, for example the groove or similar. The side plane contact means particularly comprises a number of contact members which may be disposed in many different manners, regularly or irregularly, for example groupwise, at one end or at two ends of the guide rail or throughout the length of the guide rail. The side plane contact means, e.g. the contact members, may be placed either on one side or on both sides of the board receiving portion. In the board guide rail openings or grooves are provided to allow the flexible or displaceable, also called board contact means to be moved or transferred between the first and second state.

Therefore also a printed circuit board is provided which is adapted to be usable or assembled in a board guide rail as discussed above, either on one edge with an ordinary board guide rail receiving the other opposite edge of the circuit board, or a board which is adapted to be received in board guide rails according to the inventive concept on two opposite edges wherein the board guide rails are in agreement with any one of the embodiments described above. The printed circuit board particularly comprises contacts disposed regularly or irregularly, for example in groups or at one or at two ends of a side edge or on both side edges of the board, either on one or on both sides or on both sides, preferably, but not necessarily in addition to at the back edge for conventional contact with a backplane.

### BRIEF DESCRIPTION OF THE DRAWINGS

The invention will in the following be further described in a non-limiting manner, and with reference to the accompanying drawings, in which:

FIG. 1 shows a simplified example of a board connection housing arrangement according to a first embodiment of the invention,

FIG. 2 shows an alternative board connection housing arrangement according to a second embodiment with conventional board guide rails on one side,

FIG. 3 shows an example of a Printed Circuit Board (PCB) with a backplane contact and in addition thereto side plane contacts according to the present invention,

FIG. 4 is a cross-sectional partial side elevation view of a circuit board inserted into two board guide rails in contact with side contact planes,

FIG. 5 shows a first embodiment of a board guide rail with flexible or displaceable board contact means in a first state,

FIG. 6 shows a board guide rail as in FIG. 5 with the flexible or displaceable contact means in a second state when a board is introduced into the receiving portion according to one implementation,

FIG. 7 shows the board guide rail as in FIG. 5 but with the flexible or displaceable contact means in a second state when a board is introduced into the receiving portion according to a second implementation,

FIG. 8 shows an exemplary contact control means, which for example can be used with a board guide rail as in the embodiment of FIG. 5,

FIG. 9 is a perspective view of a board guide rail and a contact control means according to one embodiment of the present invention,

FIG. 10A shows another embodiment of a board guide rail with a flexible or displaceable contact means in a first state,

FIG. 10B shows the board guide rail of FIG. 10A but with the flexible or displaceable contact means in a second state when a circuit board is introduced into the receiving portion,

FIG. 11A shows still another embodiment of a board guide rail with flexible or displaceable contact means in a first, or contact-less, state and

FIG. 11B shows the board guide rail of FIG. 11A with the flexible or displaceable contact means in a second (contact) state when a board has been introduced into the receiving portion.

### DETAILED DESCRIPTION OF THE INVENTION

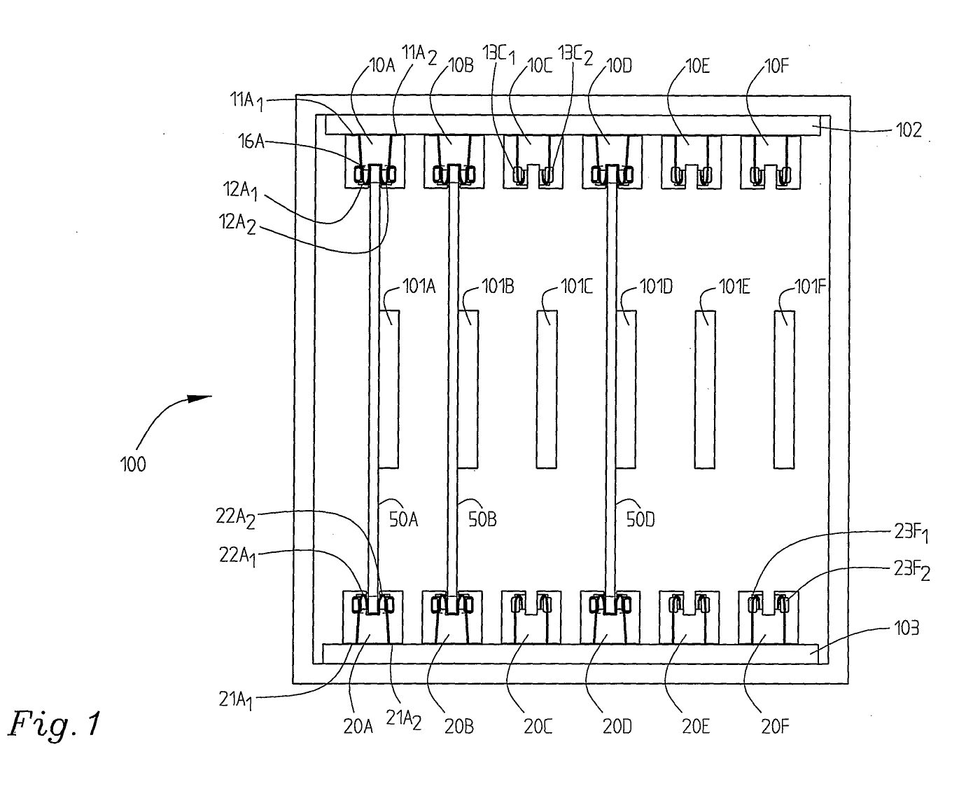

FIG. 1 shows a first embodiment of a board connection housing 100 comprising a number of first board guide rails 10A,10B, . . . , 10F and a number of second board guide rails 20A,20B, . . . , 20F. It should be clear that the number of board guide rails is not significant for the functioning of the present invention and that, normally, the number of board guide rails is much higher than shown in this figure. In the front view of the board connection housing the backplane is merely illustrated through the backplane contacts 101A,101B, . . . , 101F. There are no restrictions as to how such backplane contacts of the backplane should be arranged and constituted and the present invention is actually not dependent on the provisioning of any backplane at all, although preferably a backplane is provided in a conventional manner and contact may be provided via pins and sleeves or in any other appropriate manner. A conventional contacting procedure may require a certain force, but the contacting may also be provided in such a manner that substantially no force is required as far as backplane contacting is concerned, a force connector.

According to the invention the board connection housing comprises a first side contact plane 102 and a second side contact plane 103, each comprising side plane contact regions.

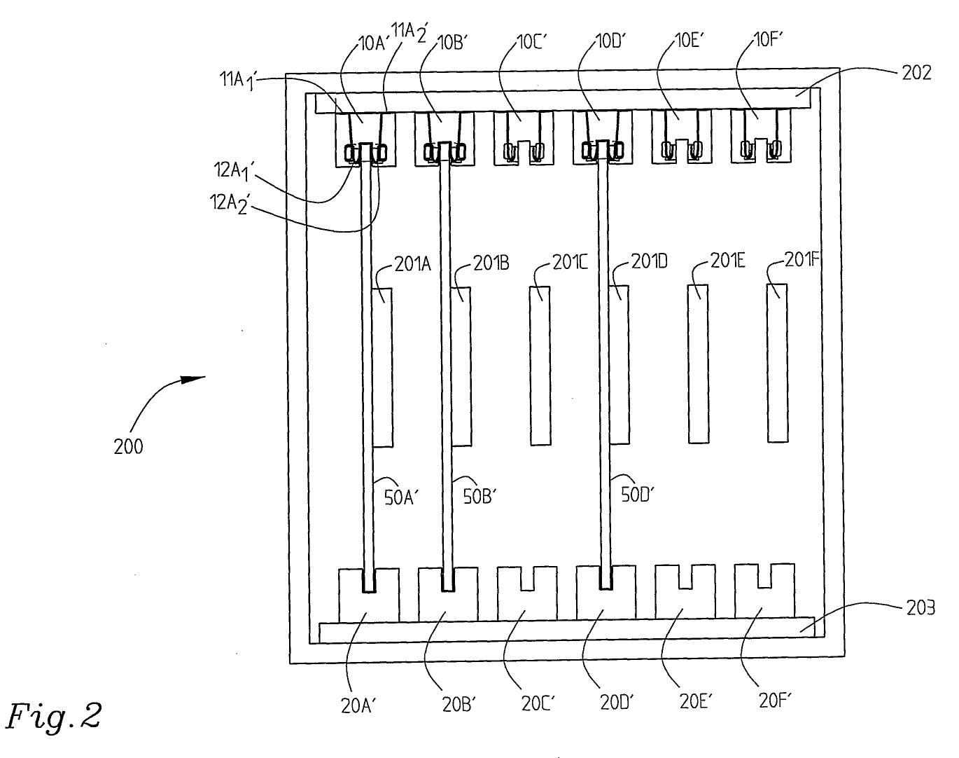

It should be clear that the inventive concept also covers embodiments with only one side plane or particularly only one side contact plane with side plane contact regions, cf. also FIG. 2.

In the embodiment shown in FIG. 1 all of the first and second board guide rails 10A,10B, . . . , 10F, 20A,20B, . . . , 20F are provided with side plane contact means 11A₁,11A₂, . . . , 11F₁,11F₂; 21A₁,21A₂, . . . , 21F₁, 21F₂ which are capable of getting in contact with respective of the said first or second side contact planes 102,103. Further, substantially in parallel with the longitudinal extension of, here, the first and second board guide rails respective flexible or displaceable contact means 12A₁,12A₂;22F₁,22F₂ are disposed which are arranged to at least be in contact with said side plane contacts 11A₁,11A₂, . . . . This means that they may be in one piece with said side plane contacts or at least in conductive contact with them. In the embodiment -shown herein they are in one piece and actually constitute opposite ends of one and the same contact means. The flexible or displaceable contact means 12A₁,12A₂, . . . in a first, also denoted contact-less, state are so arranged that no contact is enabled with a board, whereas in the second state they are so arranged or disposed that contact is provided with a board introduced or already provided in the housing, more particularly in the respective board receiving portion of the board guide rail. Particularly contact control means are provided for bringing the flexible or displaceable contact means from the first state to the second state and vice versa or only for bringing them from one state to the other. Such contact control means can be provided for in many different manners. In the embodiment shown in FIG. 1, it is supposed that printed circuit boards 50A,50B,50D are introduced in the board guide rails 10A,10B,10D and 20A,20B,20D respectively or more particularly in the respective receiving portions, 14A,14B,14C,24A, 24B,24D thereof. FIG. 2 shows an embodiment wherein a side contact plane with contact regions is provided on one side, 102′, whereas on the opposite side no side contacting is enabled and the board guide rails on the other side simply comprise conventional board guide rails 20A′,20B′, 20C′,20D′. However, the board guide rails 10A′,10B′,10C′,10D′ substantially correspond to the board guide rails of FIG. 1 or similar. In FIG. 2 it is supposed that two printed circuit boards 50A′,50B′ are introduced between respective cooperating board guide rails 10A′,20A′ and 10B′,20B′ respectively and that side plane contact is enabled between the first side plane 102′ and side plane contact means 11A₁′,11A₂′,11B₁′,11B₂′. In other aspects the board guide rails 10A′, . . . , 10D′ are similar to those of FIG. 1 with flexible or displaceable contact means capable of contacting an introduced board, 50A′,50B′ in the second state. Although in FIG. 2 an embodiment is illustrated in which all board guide rails on one side are equipped with side contact means, also embodiments are plausible wherein some, i.e. not all, of the board guide rails on one side are equipped with side contact means and some of the board guide rails on the other side also are equipped with board contact means, here hence requiring both a first and a second side plane. Also here backplane contact regions 201A,201B,201C,201D are illustrated, which however not are necessary for the functioning of the present invention or which could be provided for in any appropriate manner.

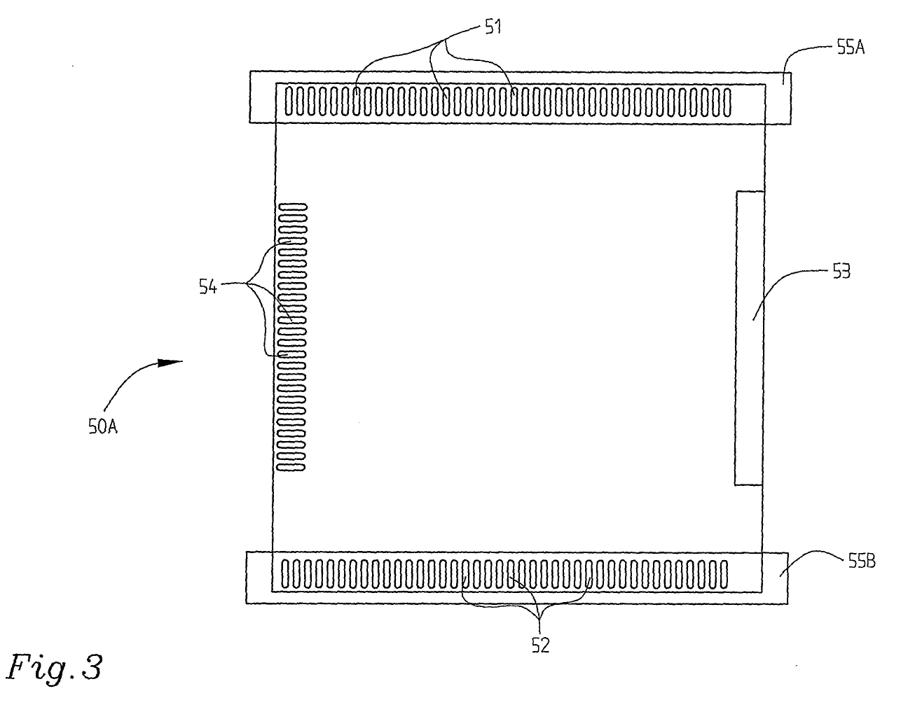

FIG. 3 here schematically illustrates a printed circuit board 50A according to the present invention with a conventional backplane contact 53, and additionally being equipped with side plane contact means 51, 52 forming a part of the pattern of the circuit board. In this particular implementation also front contact means 54 are provided on the “front side” of the circuit board. This merely relate to an advantageous implementation and they are of course not necessary, or may be not even desired, for carrying out the inventive concept. It should also be clear that it is possible to have circuit boards with side contacts only on one side, i.e. the contact elements 51 could be provided whereas the other contact elements 52 are not. Schematically illustrated are means 55A,55B facilitating running in the receiving portion of the respective board guide rails. This can be appropriate in some cases, but they are not necessary for the functioning of the inventive concept, in which case reference numerals 55A,55B merely indicate a conceptual frame around the portions of a circuit board to be introduced into the receiving portions of the respective board guide rails, or the extension of the respective board guide rail portions with a board taken up in the receiving portion.

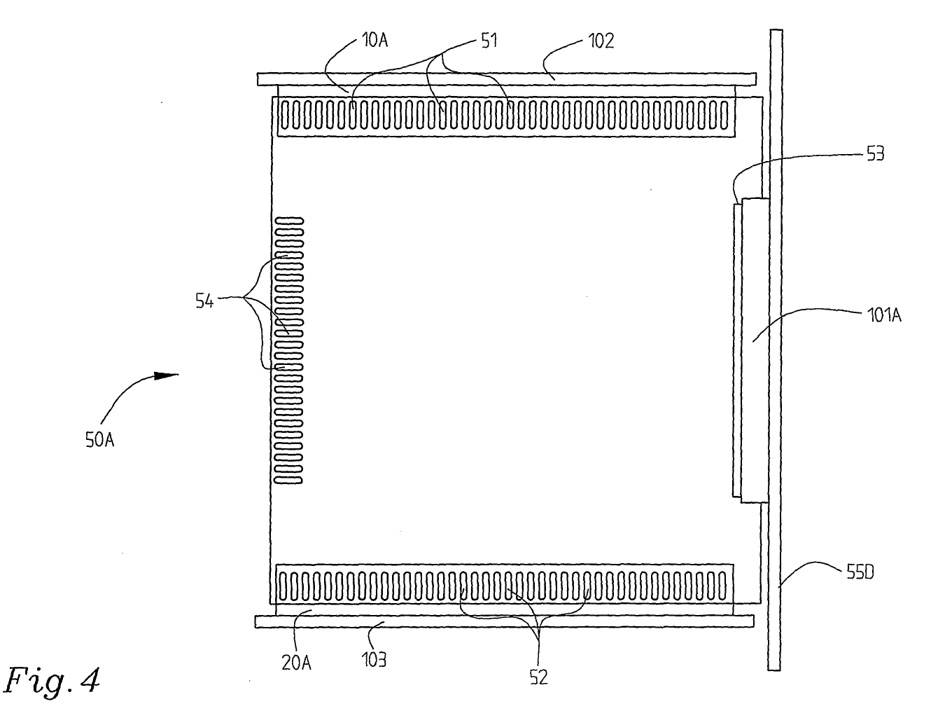

FIG. 4 schematically illustrates the circuit board 50A as introduced in the board guide rail 10A and the board guide rail 20A respectively. In FIG. 4 particularly the first and second side contact planes 102,103 are illustrated and hence how contact is established between the contact elements 51 with the side contact plane 102 and the contact elements 52 with the side contact plane 103 respectively via the side plane contact means 10A,20A. Also in this embodiment backplane contact 101A is illustrated. It should be clear that, although the contact elements 51,52 here are illustrated as being regularly arranged throughout respective edge, they could also be arranged groupwise, with different pitches or varying pitches in many different ways.

As referred to above, it should also be clear that the test contacts 54 in the front are not at all necessary for the functioning of the inventive concept.

Also the backplane contact is not part of the main inventive idea.

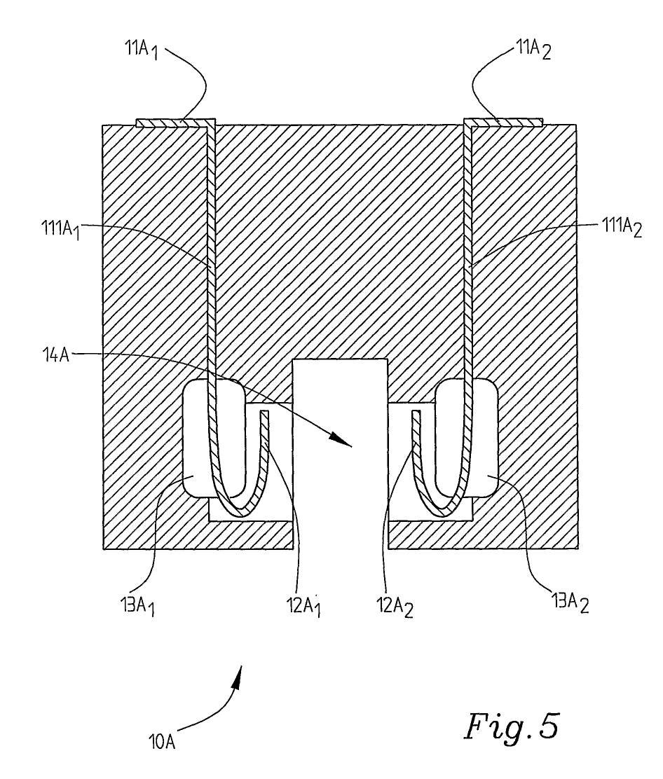

FIG. 5 shows, in a cross-sectional side view at a location where one pair of the side and flexible/displaceable contact means are located, a first embodiment of a board guide rail 10A which comprises side plane contact means 11A₁,11A₂ and flexible; or displaceable (board) contact means 12A₁,12A₂ which here are in a contact-less first state, or a retracted state, leaving the receiving portion 14A free. In this embodiment the first side plane contact 11A₁ is in one piece with the first flexible or displaceable (board) contact means 12A₁ in the form of a spring 111A₁ and likewise the first side plane contact means 11A₂ is in one piece with the flexible or displaceable contact means 12A₂ or the board contact means, in the form of a spring 111A₂. The board guide rail 10A comprises two recesses 13A₁,13A₂ forming a recess arrangement here comprising openings disposed on either side of, and in parallel with, the longitudinal board receiving portion 14A. The ends of the springs 111A₁,111A₂ terminating with board contact means 12A₁,12A₂ are displaceable due to appropriately shaped cavities or similar; otherwise they would not be capable of entering the second state. The size and shape of those cavities depend on the size and shape of the board contacts 12A₁,12A₂, or the portions of the springs 111A₁,111A₂ that have to be displaceable.

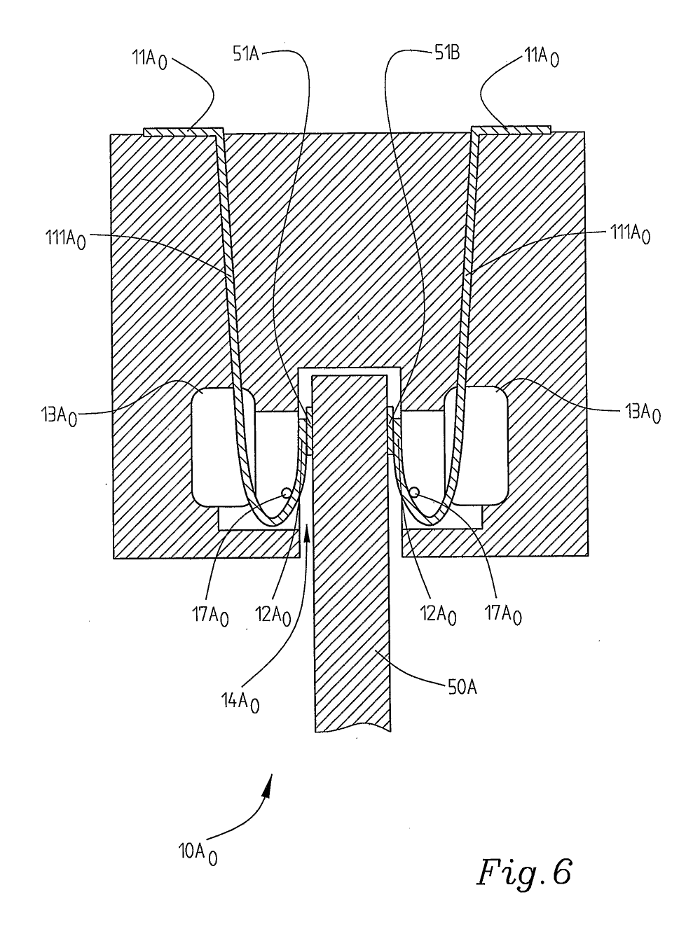

FIG. 6 shows a board guide rail 10A₀ according to an embodiment wherein the board guide rail is slightly modified as compared to the embodiment illustrated in FIG. 5. In FIG. 6 a circuit board 50A is inserted into the receiving portion 14A₀. Contact elements 51A,51B on the circuit board 50A are here in contact with flexible or displaceable contact means 12A₀,12A₀. In FIG. 6 such as to urge the flexible/displaceable (board) contact means 12A₀,12A₀ against the board contact 51A,51B, whereas in the first state (not shown) they are located such as to keep the board contact means 12A₀,12A₀ out of the receiving portion. It is here supposed that the side plane contact means 11A₀,11A₀ and the flexible or displaceable contact means 12A₀′,12A₀ comprise respective contact springs 111A₀,111A₀ disposed on either sides of the receiving portion 14A₀. It is further supposed that respective contact control means 17A₀,17A₀ are disposed on either sides of the receiving portion 14A₀ and in that upon insertion of a board 50A, the flexible or displaceable contact means 12A₀,12A₀, when the contact control means are activated, e.g. retracted into the guide rail in a direction away from the receiving portion are released and brought into contact with the board 50A such that contact is established on both sides. Also in this case it is supposed that the contact springs are urged towards or pressed against the circuit board. It should be clear that contact control means can be provided for in many different manners and here they are merely very schematically illustrated and but it should be obvious for the skilled man that several ways are possible for e.g. releasing a spring or move a contact portion from an inactive, contact-less position to an active contact position.

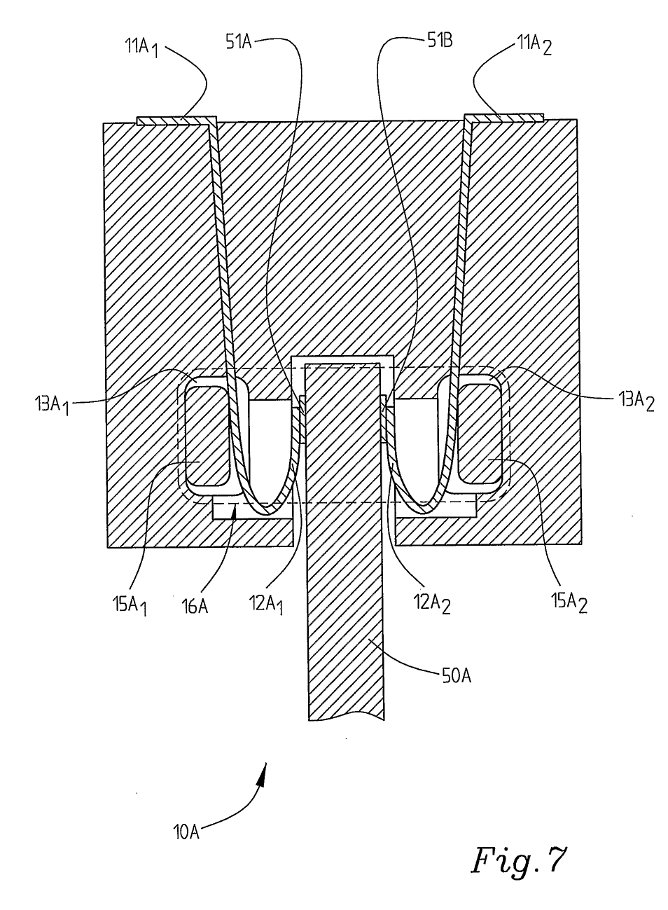

FIG. 7 shows the board guide rail 10A corresponding to FIG. 5 with a circuit board 50A inserted into the receiving portion 14A. It is here supposed that the contact control means comprises two elongate members 15A₁,15A₂ which here have been introduced into the parallel recesses 13A₁,13A₂ and which here are interconnected at the outer ends by a bridging element 16A, schematically illustrated through a dashed line, since it would not be visible where the section is made. Hence, here the elongate members 15A₁,15A₂ urge the flexible or displaceable contact means 12A₁,12A₂ against the contact members 51A,51B on the circuit board 50A. In addition thereto the contact control means 15A₁,15A₂ which, in addition to being responsible for the provisioning of the contact, also maintains the contact means 12A₁,12A₂ in place. It should be clear that if there is only one side contact plane, (or board contact means on one side) there is only required one elongate member 15A₁ or 15A₂. It is also possible to, also when there are two side plane contacts, using two separate elongate members with no bridging element 16A interconnecting them. A bridging element 16A however is advantageous in that it additionally assures that the flexible or displaceable contact means are maintained in contact with the contact member of the circuit board in a desired position and with an evenly distributed pressure or a pressure which is distributed according to the particular needs or desires. For such purposes the contact control means may have different shapes or, accordingly the flexible or displaceable contact means may have a particular shape or both may have a shape such as to meet some given requirements.

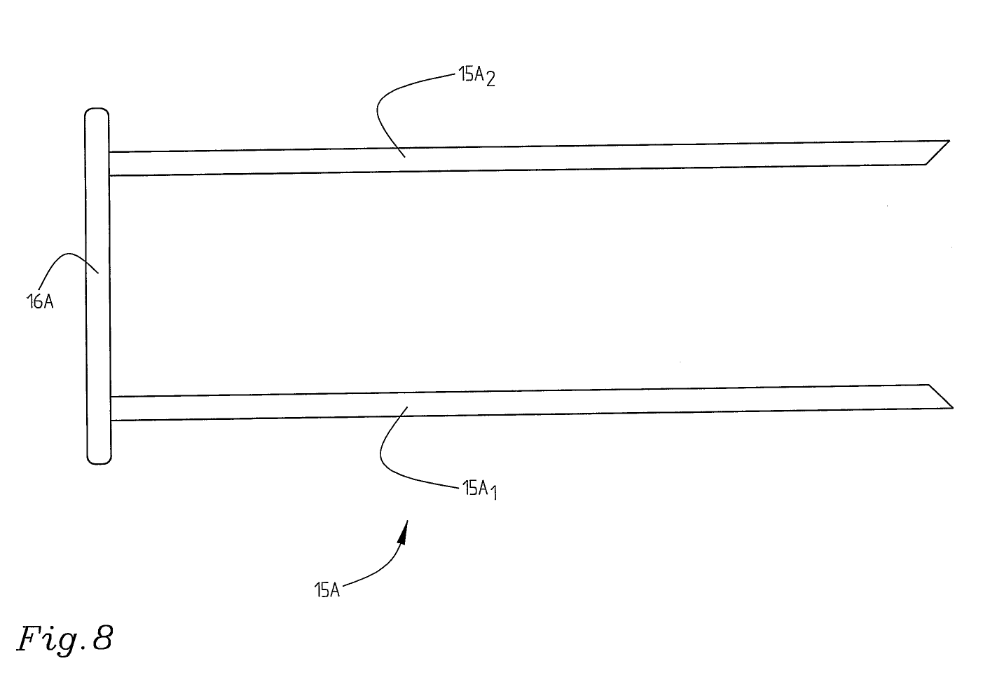

FIG. 8 shows an example of a contact control means 15A with a first elongate member 15A₁ and a second elongate member 15A₂ interconnected via bridging element 16A as disclosed in FIG. 7. Preferably the ends opposite to the bridging element 16A, or more generally the ends to be introduced into a receiving portion, are beveled in order to facilitate introduction of the contact control means 15A₁,15A₂ into the longitudinal recesses. Hence, as referred to above, preferably the contact control means 16A is used to create a contact pressure and to keep the circuit board in place.

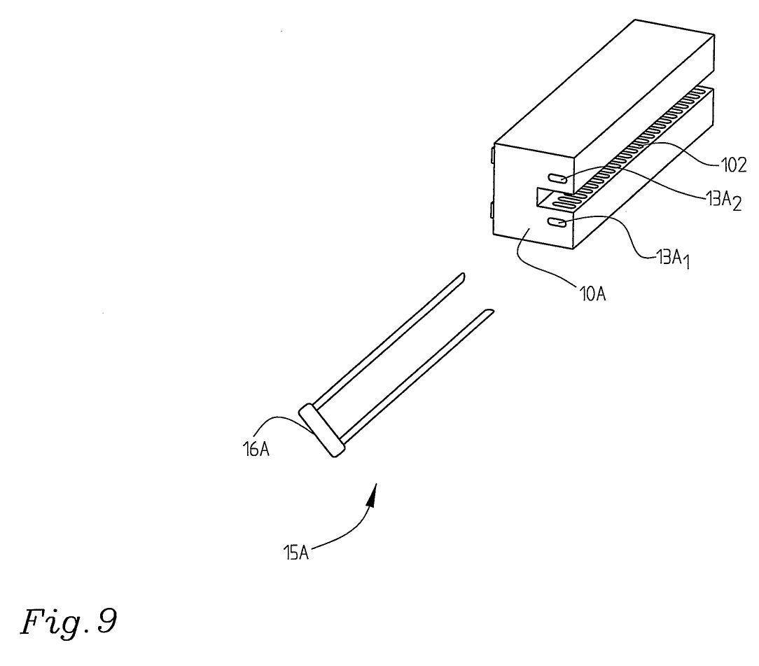

FIG. 9 is a perspective view of the board guide rail 10A with a number of contact elements, longitudinal recesses 13A₁,13A₂ here adapted to take up the contact control means 15A with two parallel elongate beveled members interconnected via bridging means 16A. The board guide rail here comprises evenly distributed contact members. As referred to earlier in the application it should be clear that the contact members could be distributed in any other appropriate manner, they could be provided on only one side or on both sides. If they are provided on one side only, of course only one elongate recess parallel with the receiving portion 14A is needed (or used). Hence, the contact members could be distributed groupwise in a regular manner or in any appropriate irregular pattern depending on the particular needs or relevant applications.

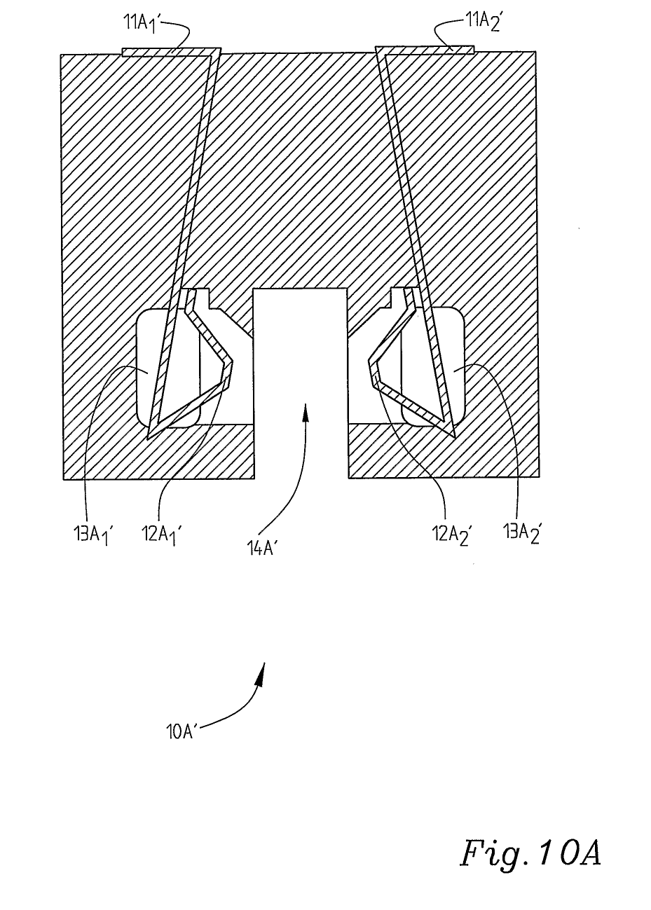

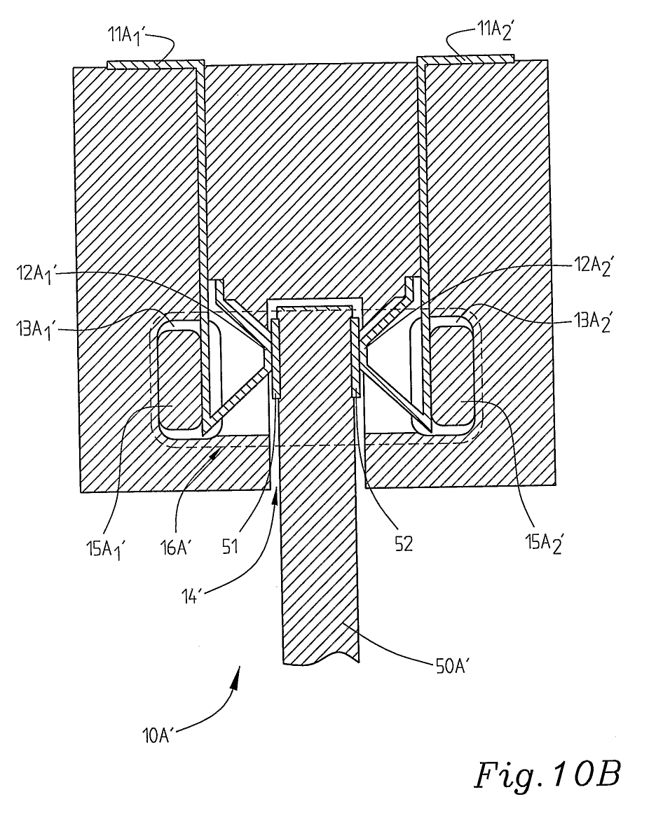

FIG. 10A shows an alternative embodiment, in cross-section such that a pair of contact means is visible, of a board guide rail 10A′ which comprises side contact means 11A₁′,11A₂′, flexible or displaceable contact means 12A₁′,12A₂′, also denoted board contact means and a receiving portion 14A′ for receiving an edge of a circuit board. Also in this case the contact means consist of a respective spring and the side contact means 11A₁′ are fixed to the board guide rail in the outer plane or extending somewhat outside the outer plane, for example moulded into a plastic guide rail whereas in the other end a movable or displaceable board contact portion 12A₁ and 12A₂ respectively is provided which can be activated by means of contact control means to be inserted into longitudinal recesses 13A₁′,13A₂′ respectively which preferably are disposed on opposite sides of the receiving portion 14A′ similar to the embodiments described with reference to FIGS. 5, 6 and 7.

FIG. 10B is a figure showing the same board guide rail as in FIG. 10A but wherein the flexible or displaceable contact means 12A₁′,12A₂′ are brought into contact with the board contacts by means of a contact control means comprising two elongate members 15A₁′,15A₂′ introduced into the corresponding recesses and urging the contact means towards and into contact with the contact elements of the circuit board 50A′. Also in this case it is supposed that the elongate members are interconnected by means of a bridging element 16A′.

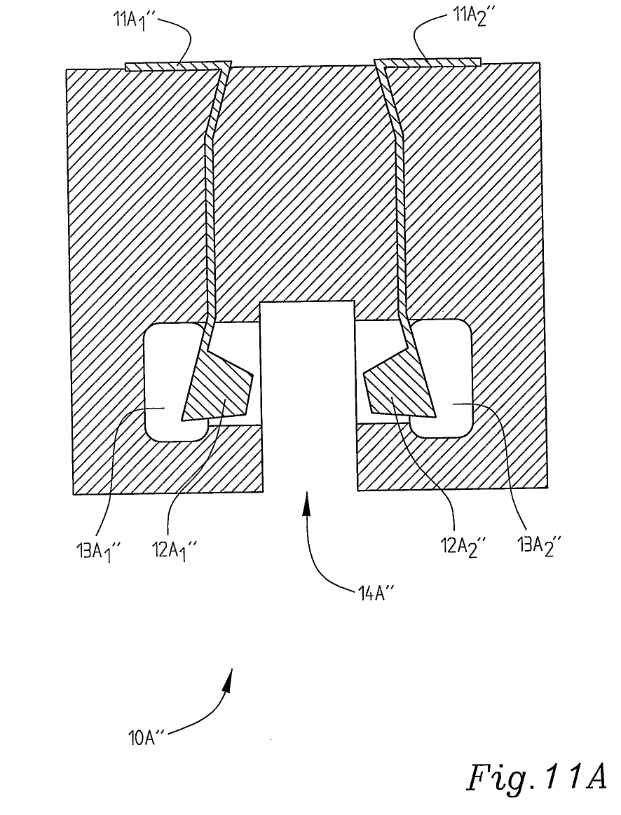

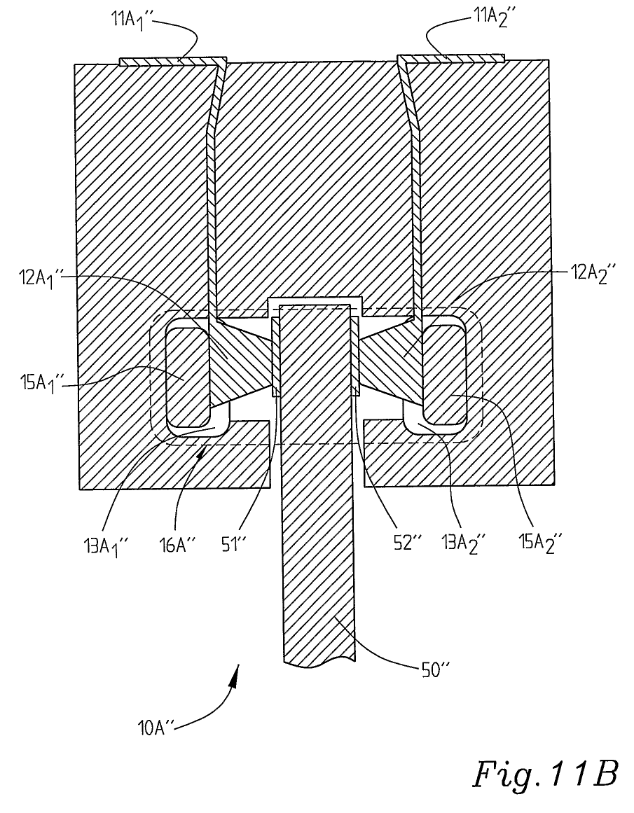

FIG. 11A shows still another embodiment of a board guide rail 10A″ wherein in side plane contacts 11A₁″, 11A₂″ are disposed on the sides of the board guide rail to provide side plane contact. In parallel with the receiving portion for receiving a board contact means are provided with substantially trapezoidally shaped heads 12A₁″,12A₂″ which may be solid or hollow and displaceably arranged in the longitudinal recesses 13A₁″,13A₂″. The board guide rail may here also consist of a plastic material or any other appropriate material constituting the board guide rail and contact can be established with the board contacts 51″,52″ when legs 15A₁″,15₂″ of contact control means are introduced into the recesses. Also in this case the legs 15A₁″,15₂″ are interconnected at the outer ends by means of a bridging element 16A″ (dashed line in FIG. 11B). It should be clear that the arrangement accordingly can be varied in a number of ways as also discussed above. The respective side plane contacts and the flexible or displaceable board contacts may be made as single pieces or interconnected in any appropriate manner. Particularly the side plane contacts may protrude from the plane of the board guide rail, partly protrude, or not protrude at all. The board contact means may be flexibly or displaceably arranged only in the area of the respective recess or also partly or entirely within the board guide rail and they may have any appropriate shape and the recesses may also have any appropriate shape, square-shaped, rectangularly-shaped, oval, elliptic, triangularly-shaped etc. Also in other aspects the invention is not limited to the explicitly illustrated embodiments.

1. A board connection housing arrangement for taking up a number of printed circuit boards e.g. comprising a backplane and preferably a number of backplane contact regions for providing contact with boards introduced into the housing and a number of one another facing first and second board guide rails having a longitudinal extension which is substantially perpendicular to the planar extension of said backplane and which are adapted to take up a respective edge portion of a board in a board receiving portion such housing comprising:
a first and a second side plane, at least one of said first or second side planes having side plane contact regions with side plane contacts, at least some of said first and/or second board guide rails provided with side plane contact means in contact with respective of said first and second side plane contact regions;
substantially in parallel with the longitudinal extension of at least some of said first and/or second board guide rails respective flexible and/or displaceable contact means arranged to be in contact with said side plane contacts, said flexible or displaceable contact means in a first contact-less state being so arranged that no contact is enabled with a board, and in a second state being so arranged that contact is provided with a board introduced or provided in a receiving portion of the housing; and
contact control means provided for bringing the flexible and/or displaceable contact means from the first state to the second state and/or vice versa.

2. A board connection housing arrangement according to claim 1, wherein the flexible and/or displaceable contact means in the first state are so arranged that a board receiving portion is free and wherein a board can be received without entering in contact with the flexible or displaceable contact means and in the second state said flexible and/or displaceable contact means are in electrical and preferably also in physical contact with an introduced board.

3. A board connection housing arrangement according to claim 1 wherein said contact control means comprises contact closing means and in that said contact closing means are adapted to bring said flexible and/or displaceable contact means from the first to the second state when contact between a board and the respective side plane at which the board guide rail is provided is desired, or automatically at completion of introduction or insertion of a board.

4. A board connection housing arrangement according to claim 1, wherein flexible and/or displaceable contact means comprises a spring device.

5. A board connection housing arrangement according to claim 4, wherein the spring device comprises spring means with a respective flexible or displaceable board contact end for, in said second state, being in contact with a board, and a second contact end, said second contact end constituting a said side plane contact means or being in contact with a said side plane contact means.

6. A board connection housing arrangement according to claim 1 wherein a number of, or all, the said board guide rails each comprise a longitudinally extending recess arrangement adapted to allow insertion or activation of a contact control means.

7. A board connection housing arrangement according to claim 6, wherein the recess arrangement comprises two parallel recesses extending on opposite sides of the board receiving portion and in that the contact control means comprises two elongate members or legs adapted to be introduced into said parallel recesses, said elongate members or legs being interconnected at one end thereof by a bridging element.

8. A board connection housing arrangement according to claim 1 wherein the first and/or a second board guide rail flexible and/or displaceable board contact means comprise a number of contact members arranged along at least one of the sides of the receiving portion adapted to receive a board, the contact members being arranged regularly with a given pitch along said at least one side and/or group wise with a regular or irregular pitch.

9. A board connection housing according to claim 6 wherein said contact control means are adapted to bring the flexible and/or displaceable contact means into the second state upon introduction into the recess/recesses.

10. A board connection housing arrangement according to claim 1 wherein the contact control means are adapted to bring the flexible and/or displaceable contact means into the second state upon removal from said recess/recesses or upon actuation, e.g. by rotation thereof.

11. A longitudinal board guide rail for taking up one outer edge of a circuit board being provided in a board connection housing and comprising:
a board receiving portion, having a groove or similar for receiving the circuit board edge, wherein it comprises side plane contact means, and a flexible and/or displaceable board contact means having or being associated with said side plane contact means, and in that said flexible and/or displaceable contact means in a first state are so arranged or disposed that no contact is enabled with a board having a board insertion or contact-less state, and in a second state, having a contact state, are so arranged that contact is established with a board introduced or provided in the board receiving portion.

12. The longitudinal board guide rail according to claim 11, that the flexible and/or displaceable board contact means are adapted to be actuated by contact control means such that through interaction with said contact control means said flexible and/or displaceable contact means can be brought from said first to said second state and/or vice versa and/or that the flexible and/or displaceable contact means in the first state are so arranged that the board receiving portion is free and in that a board can be received without entering in contact with the flexible and/or displaceable contact means.

13. The longitudinal board guide rail according to claim 11, wherein said flexible and/or displaceable contact means comprises a spring device.

14. The longitudinal board guide rail according to claim 13, wherein the spring device comprises spring means with a respective board contact end adapted to, in said second state, be in contact with a board and a second contact end, said second contact end constituting said side plane contact means or being directly or indirectly in contact with said side plane contact means, the spring device comprising first and second spring means being oppositely directed and adapted to be capable of, in said second state, contacting opposite sides of a board edge.

15. The longitudinal board guide rail according to claim 11, in combination with a printed circuit board wherein it at least comprises contacts disposed regularly or irregularly, e.g. In groups, at one or at two sides at least along one side edge of the board and in that it also comprises contacts at the back edge.
